(19) United States
(12) Patent Application Publication
(10) Pub. No.: US 2014/0241241 A1
(43) Pub. Date: Aug. 28, 2014

(54) Method and apparatus for supporting short message services for packet switched devices

(71) Applicant: ALCATEL-LUCENT USA, INC., Murray Hill, NJ (US)

(72) Inventor: Jennifer J-N Liu, Plano, TX (US)

(73) Assignee: ALCATEL-LUCENT USA, INC., Murray Hill, NJ (US)

(21) Appl. No.: 13/780,549

(22) Filed: Feb. 28, 2013

(51) Int. Cl. H04W 4/14

(52) U.S. Cl. CPC H04W 4/14
USPC 370/328

(57) ABSTRACT

Embodiments of the claimed subject matter provide a method and apparatus for supporting short message services (SMS) for packet switched devices. One embodiment of the method includes providing, from user equipment, a request for packet-switched (PS) service or combined packet-switched (PS) service and circuit-switched (CS) service. The request includes an indication that the user equipment is requesting short message services (SMS) and is not requesting any other CS services. Some embodiments of the method also include receiving, at the user equipment, a response indicating whether the SMS services are supported by a PS domain.

### CROSS REFERENCE TO RELATED APPLICATIONS

This application claims priority to U.S. Provisional Patent Application 61/620,161, filed on Apr. 4, 2012, which is hereby incorporated herein by reference in its entirety.

### BACKGROUND

This application relates generally to communication systems, and, more particularly, to wireless communication systems.

Short message service (SMS) messages were originally designed to be transmitted over circuit-switched (CS) telephony systems. SMS service is a very popular service and has been adopted by subsequent generations of mobile communication standards. For example, mobile switching centers (MSCs) that operate according to second-generation (2G) or third-generation (3G) standards support SMS messaging over CS connections, e.g., using GSM standards or protocols implemented by the MSC. Conventional SMS services may also be provided by packet switched (PS) systems using Non-Access Stratum (NAS) signaling. For example, General Packet Radio Service (GPRS) wireless communication standards support SMS messaging using packet-switched (PS) services over NAS, e.g., using network elements that operate according to the general packet radio service (GPRS) standards or protocols. A 2G/3G communication system may include both MSCs that can support SMS messaging over CS connections and serving GPRS support nodes (SGSNs) that can support SMS messaging over PS connections.

User equipment can be configured to attach to CS networks, PS networks, or both. For example, GPRS handsets in a 2G/3G system can attach to both the CS and PS networks when operating in mode A or mode B, and when a GPRS handset is operating in mode C the handset can attach exclusively to either a CS or PS network at one time. User equipment operating in modes A or B can register for either PS services via the PS network or combined PS/CS communication sessions that involve both the PS network and the CS network. Some embodiments of the user equipment can therefore request both CS and PS services, in which case network resources are allocated in both CS and PS domains and SMS messaging can be offered through either domain.

User equipment may also include machine type communication (MTC) devices. An MTC device is defined by the 3GPP TS 22.368 as user equipment equipped for Machine Type Communication. An MTC device can be a wireless communication device (e.g., a smart phone, a laptop, or a tablet) with an MTC application installed on it or the MTC device can be a device that is specific for an MTC purpose and communicates wirelessly to an MTC server, such as a water meter or health monitoring device. Machine type communication is a form of data communication that involves one or more entities that do not necessarily need human interaction. A service optimised for machine type communications differs from a service optimised for human-to-human communications. For example, machine type communications differs from current mobile network communication services because machine type communication may involve different market scenarios, data communications, lower costs and effort, a potentially very large number of communicating terminals, and to a large extent, relatively little traffic per terminal An MTC device may use SMS services. For example, an MTC server may transmit triggers to one or more MTC devices using SMS messages. The triggers signal that the MTC device should begin collecting data. The MTC device can also transmit the collected data back to the MTC server, e.g., using a PS connection to the network.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

As discussed herein, user equipment may connect to the network using PS and CS services or PS-only services. For example, user equipment may request PS services and SMS services that may be provided in either a PS domain or a CS domain. The user equipment may be able to receive PS services via a connection to an SGSN in the PS domain and the user equipment may receive SMS services using either the connection to the SGSN in the PS domain or a separate connection to a mobile switching center (MSC) or visitor location register (VLR) in the CS domain. Providing the SMS services in the CS domain requires establishing a CS connection in addition to the PS connection used for PS services. Thus, user equipment may conserve air interface resources by receiving both the PS services and the SMS services from the PS domain. However, not all deployed SGSNs or networks support SMS via PS domain, e.g., using NAS.

Since support of SMS services via PS domain NAS is a network deployment option and may depend also on roaming agreements, a PS-only plus SMS subscription should allow the SMS services be provided via CS domain in case SMS via PS domain NAS is not supported. In this case, user equipment should be able to inform the network that it is only requesting CS services to support SMS services and the user equipment does not intend to register for any other CS services. This type of registration is typically referred to as a request for “SMS-only” service, which can be provided using only signaling channels such as PS domain NAS or CS signaling channels. In many cases, SMS-only services can be provided by either the PS domain or the CS domain. The network should also be able to inform user equipment during registration whether the network supports SMS via PS domain NAS and whether SMS services are provided by the SGSN or not. If SMS services are provided by the SGSN, no registration in the CS domain needs to be performed. Establishing a CS connection for user equipment may waste valuable network resources if the user equipment has requested SMS-only services and the network can provide the SMS-only services using a PS connection.

The disclosed subject matter is directed to addressing the effects of one or more of the problems set forth above.

In one embodiment, a method is provided for supporting short message services (SMS) for packet switched devices. One embodiment of the method includes providing, from user equipment, a request for packet-switched (PS) service or combined PS and circuit-switched (CS) service. The request includes an indication that user equipment is requesting short message services (SMS) and is not requesting any other CS services. Some embodiments of the method also include receiving, at the user equipment, a response indicating whether the SMS services are supported and provided by a PS domain. Embodiments of user equipment that implement embodiments of the method are also provided.

In another embodiment, a method is provided for supporting short message services (SMS) for packet switched devices. One embodiment of the method includes receiving, at a node in a packet-switched (PS) network, a request for PS service or combined PS and circuit-switched (CS) service for user equipment. The request includes an indication that the user equipment is requesting short message services (SMS) and is not requesting any other CS services. Some embodiments of the method also include providing, from the node, signaling indicating that the node supports the SMS services and indicating that the request is for SMS-only service. Some embodiments of the method further include receiving, at the node in response to providing the signaling, a response indicating whether the SMS services are supported by a PS domain. Embodiments of nodes that implement embodiments of the method are also provided.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a wireless communication system;

FIG. 2 conceptually illustrates a first exemplary embodiment of a method of SMS-only messaging;

FIG. 3 conceptually illustrates a second exemplary embodiment of a method of SMS-only messaging;

FIG. 4 conceptually illustrates a third exemplary embodiment of a method of SMS-only messaging; and

FIG. 5 conceptually illustrates one exemplary embodiment of a method of handling SMS-only requests in systems that do not support combined request for PS services and CS services.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

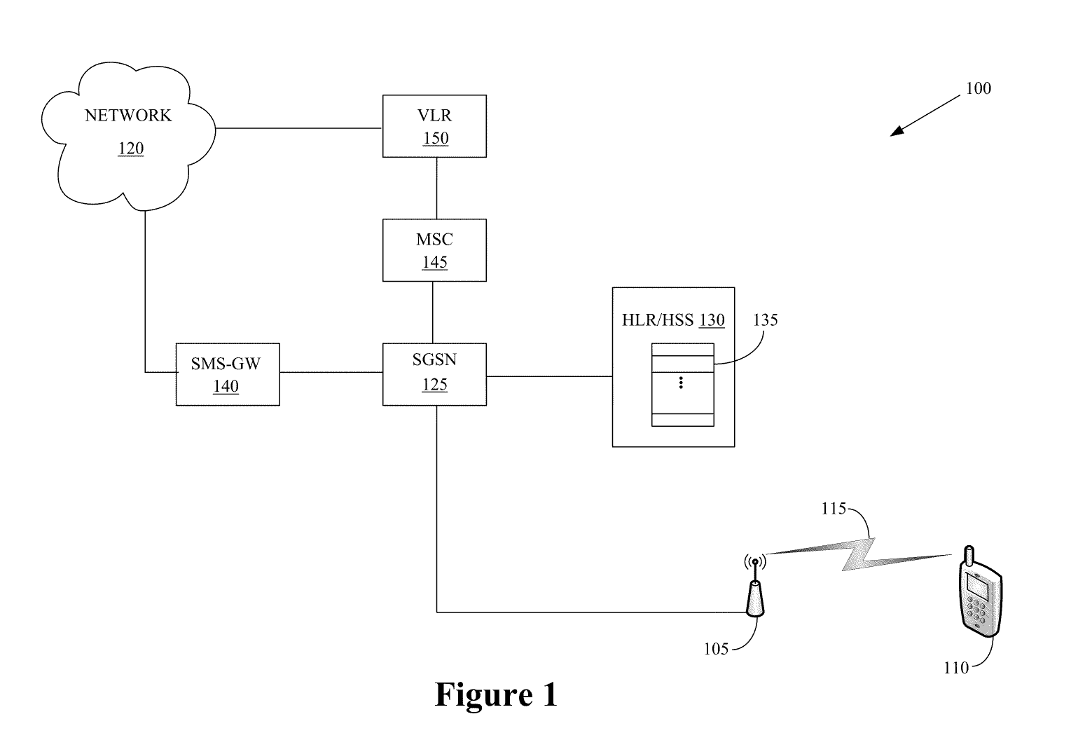

FIG. 1 conceptually illustrates one exemplary embodiment of a wireless communication system 100. In the illustrated embodiment, the wireless communication system 100 includes one or more base stations 105 that can be used to provide wireless connectivity to user equipment 110 over an air interface 115. As used herein, the term “base station” is understood to encompass devices for providing wireless connectivity including radio access network, base station routers, access points, macrocells, microcells, femtocells, picocells, and the like. User equipment 110 may include devices such as smart phones, cellular phones, tablet computers, laptop or notebook computers, network interface cards, desktop computers, and the like. Some embodiments of the user equipment 110 may also include devices that utilize machine type communication (MTC) standards or protocols.

Embodiments of the wireless communication system 100 illustrated in FIG. 1 may include a network switching subsystem (NSS) or GSM core network, which is the portion of the wireless communication system 100 that carries out call switching and mobility management functions for user equipment 110 roaming on the network of base stations including the base station 105. The NSS is typically owned and deployed by mobile phone operators and allows user equipment 110 to communicate with each other and entities via a network 120 such as public switched telephone network (PSTN) or a public land mobile network (PLMN). Embodiments of the wireless communication system may therefore implement features and functions to support mobility because the user equipment 110 may not necessarily be fixed in one location. The NSS may include a circuit-switched (CS) core network that can be used for services such as voice calls, SMS, and CS data calls. Some embodiments of the NSS may be extended by overlaying entities that provide packet-switched (PS) data services.

Portions of the wireless communication system 100 may operate according to the general packet radio service (GPRS) standards or protocols. The GPRS standards define a number of interfaces that are typically referred to using the notation “G_” and the underscore is filled with a distinguishing letter. Definitions of these interfaces are known in the art and in the interest of clarity only those aspects of these interfaces that are relevant to the claimed subject matter are discussed herein. Embodiments of the wireless communication system 100 may therefore implement one or more serving GPRS support nodes (SGSNs) 125. The SGSN 125 is responsible for the delivery of data packets to and from the user equipment 110 within a geographical service area associated with the SGSN 125. For example, the SGSN 125 may communicate with the base station 105 over a Gb interface using frame relay or IP protocols. Tasks that may be performed by the SGSN 125 may include packet routing and transfer, mobility management (attach/detach and location management), logical link management, and authentication and charging functions. Some embodiments of the wireless communication system 100 may support the GPRS Tunneling Protocol (GTP), which is an Internet protocol (IP) based protocol that allows end users to move from place to place while continuing to connect to the Internet as if from one location, e.g., at a Gateway GPRS support node (GGSN, not shown in FIG. 1). The GTP protocol may be used to carry data associated with user equipment 110 from the SGSN 125 to the GGSN that is handling the session.

The wireless communication system 100 includes a home location register (HLR)/home subscriber server (HSS) 130 that is communicatively coupled to the SGSN 125. For example, the HLR/HSS 130 and the SGSN 125 may communicate over a Gr interface using the MAP3 protocol. The HLR/HSS 130 is a central database that contains details of each mobile phone subscriber (e.g., the user equipment 110) that is authorized to use the network. Some embodiments of the HLR/HSS 130 may therefore include a database that includes one or more user profiles 135 for storing information associated with the user equipment 110. For example, the HLR/HSS 130 may include user profiles 135 for storing details of SIM cards issued by the mobile phone operator. Each SIM has a unique identifier called an IMSI which is the primary key to each HLR/HSS record. Some embodiments of the user equipment 110 may implement a SIM card (not shown in FIG. 1). The user profiles 135 may also be used to store MSISDNs, which are the telephone numbers used by user equipment 110 to make and receive calls. For example, a primary MSISDN may be used for making and receiving voice calls, as well as sending or receiving SMS messages. Each MSISDN may also be a primary key to the corresponding user profile 135. The user profile 135 may be retained in the HLR/HSS 130 for as long as a subscriber remains with the mobile phone operator. Examples of other data stored in the HLR/HSS 130 include information indicating services that the subscriber has requested or been given, GPRS settings to allow the subscriber to access packet services, a current location of subscriber (VLR or SGSN), call divert settings applicable for each associated MSISDN, and the like. The HLR/HSS 130 may also receive and process MAP transactions and messages from elements in the wireless communication system 100, for example, the location update messages or routing area update messages received from roaming user equipment 110.

The SGSN 125 may also be communicatively connected to an SMS gateway (SMS-GW) 140 that may be used to support SMS messaging to and from the network 120. For example, the SGSN 125 and the SMS-GW 140 may communicate over a Gd interface between the SGSN 125 and the SMS-GW 140 using MAP1, MAP2 or MAP3 standards or protocols defined for the GPRS network. Some embodiments of the SGSN 125 can support SMS messaging in the PS domain using Non-Access Stratum (NAS) signaling. These embodiments of the SGSN 125 may therefore exchange SMS messaging using NAS signaling over the Gd interface.

The wireless communication system 100 shown in FIG. 1 includes a mobile switching center (MSC) 145 that is communicatively coupled to the SGSN 125. For example, the MSC 145 and the SGSN 125 may communicate over a Gs interface using the BSSAP+ protocol. Embodiments of the Gs interface may support paging and station availability when it performs data transfer. For example, when the user equipment 110 is attached to the GPRS network, the SGSN 125 keeps track of the routing area (RA) associated with the user equipment 110. An RA may be a part of a larger location area (LA). When the user equipment 110 is paged this information is used to conserve network resources while searching for the user equipment 110. Some embodiments of the MSC 145 may implement functionality for setting up or releasing the end-to-end connection with the user equipment 110, handling mobility and hand-over requirements during the call and taking care of charging and real time pre-paid account monitoring. Persons of ordinary skill in the art having benefit of the present disclosure should appreciate that different names may be used to refer to the MSC 145 in different contexts.

A visitor location register (VLR) 150 may be used to store a database of subscribers who have roamed into the jurisdiction of the MSC 145. Each base station 105 in the network 100 is served by one VLR 150. The data stored in the VLR 150 has either been received from the HLR/HSS 130 or collected from the user equipment 110. Some embodiments may integrate the VLR 150 and the MSC 145 in a single entity or the VLR 150 may be linked with the MSC 145 via a proprietary interface. Some embodiments of the VLR 150 may store information including the IMSI of the user equipment 110, authentication data, the MSISDN of the user equipment 110, information indicating services that the user equipment 110 is allowed to access, access point (GPRS) subscribed, or the HLR/HSS address of the user equipment 110. The VLR 150 and the MSC 145 are part of the CS domain of the wireless communication system 100. User equipment 110 may therefore access SMS services using a CS connection to the MSC 145 and VLR 150 in the CS domain.

As discussed herein, support of SMS services via PS domain NAS is optional and thus a “PS-only+SMS-only” subscription should allow the SMS services to be provided via CS domain in case SMS via PS domain NAS is not supported. In this case, user equipment 110 may inform the wireless communication system 100 that it is requesting SMS services and the user equipment 110 does not intend to register for any other CS services, e.g., the user equipment 110 is requesting “SMS-only” service. Some embodiments of the user equipment 110 may therefore provide a combined request for PS service and CS service. The combined request includes an indication that the user equipment 110 only requests short message services (SMS). The user equipment 110 may then receive a response indicating whether the SMS services are supported by a PS domain.

Some embodiments of the wireless communication system 100 may also be able to inform user equipment 110 whether the wireless communication system 100 supports SMS via PS domain NAS and whether SMS services are provided by the SGSN 125 or not. If SMS services are provided by the SGSN 125, no CS side registration needs to be performed and so establishment of a CS connection may be bypassed, thereby conserving valuable network resources when the user equipment 110 has requested SMS-only services and the network can provide the SMS-only services using a PS connection. Some embodiments of the SGSN 125 may therefore be able to receive a combined request for PS service and CS service from the user equipment 110. As discussed herein, the combined request may include information indicating that the request is for SMS-only services. The SGSN 125 may then signal the HLR/HSS 130 to inform the HLR/HSS 130 that the SGSN 125 supports the SMS services and indicating that the combined request from the user equipment 110 is for SMS-only service. The HLR/HSS 130 may then use information in the user profiles 135 to determine whether the PS domain supports SMS services and whether the user equipment 110 is eligible for SMS services in the PS domain. The SGSN 125 may then receive a response from the HLR/HSS 130 that indicates whether the SMS services are available via the PS domain.

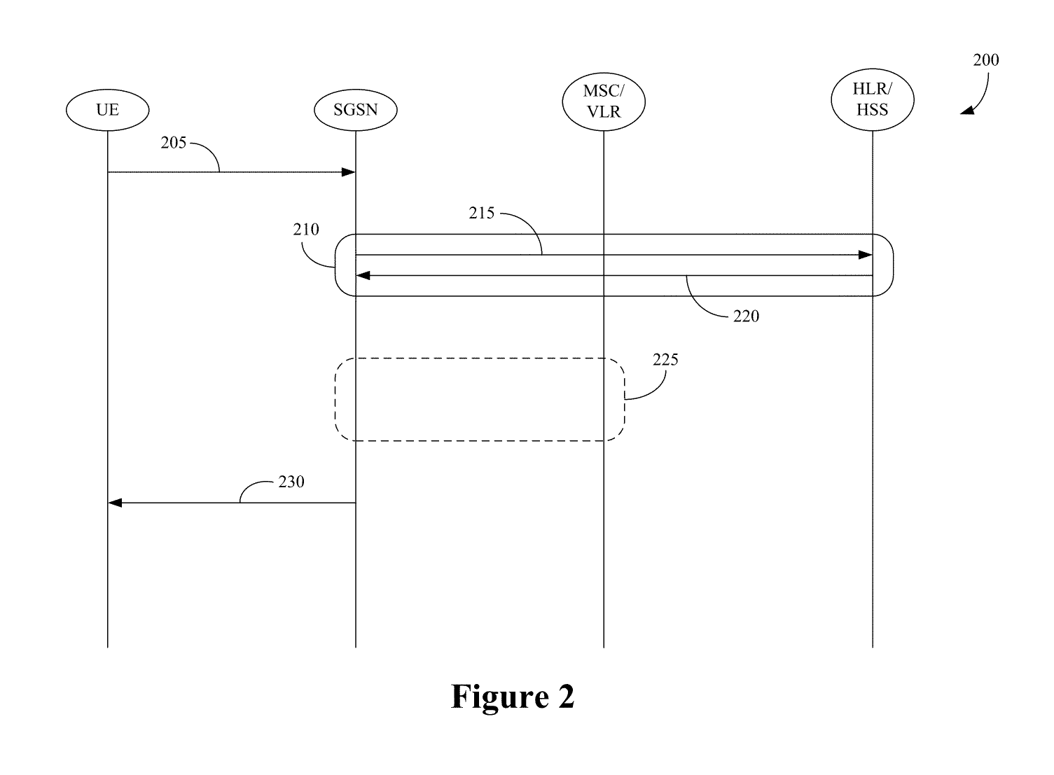

FIG. 2 conceptually illustrates a first exemplary embodiment of a method 200 of SMS-only messaging. In the illustrated embodiment, user equipment (UE) provides a request for services to an SGSN at 205. For example, the UE may provide (at 205) an ATTACH REQUEST that includes information indicating that the attach type is a combined GPRS service and non-GPRS service request so that the UE is requesting PS services and CS services. The ATTACHED REQUEST may be transmitted when the UE first attaches to the wireless communication system. For another example, the UE may provide (at 205) a ROUTING AREA UPDATE REQUEST that includes information indicating that the attach type is a combined GPRS service and non-GPRS service request so that the UE is requesting PS services and CS services. The ROUTING AREA UPDATE REQUEST may be transmitted when the UE roams into a location area or routing area served by the SGSN. The ATTACH REQUEST or ROUTING AREA UPDATE REQUEST includes an additional parameter to indicate whether the UE is requesting for “SMS-only” service or not. This parameter is set to indicate that the UE is requesting SMS-only service in the illustrated embodiment.

The SGSN may then initiate an update location procedure 210 to the HLR/HSS. In the illustrated embodiment, the SGSN transmits (at 215) signaling indicating that the SGSN supports SMS in SGSN and the UE has requested SMS-only service. The HLR/HSS also supports SMS in SGSN so the HLR/HSS responds (at 220) to the SGSN by signaling that SMS in SGSN is supported. Some embodiments of the response (at 220) may include information indicating the UE's subscription info such as the SMS subscription data. For example, the HLR/HSS may retrieve this information from a database such as the user profiles 135 shown in FIG. 1. Since the SMS-only service is supported by the PS domain, the SGSN can bypass establishment of a CS connection with the MSC/VLR, as indicated by the dashed box 225. For example, the SGSN may not perform a location update for non-GPRS services towards the VLR and a Gs association between the SGSN and the MSC/VLR may not be established. The SGSN may then signal (at 230) the UE that SMS via PS domain NAS is supported by the SGSN. For example, the SGSN may transmit an Attach Accept message at 230.

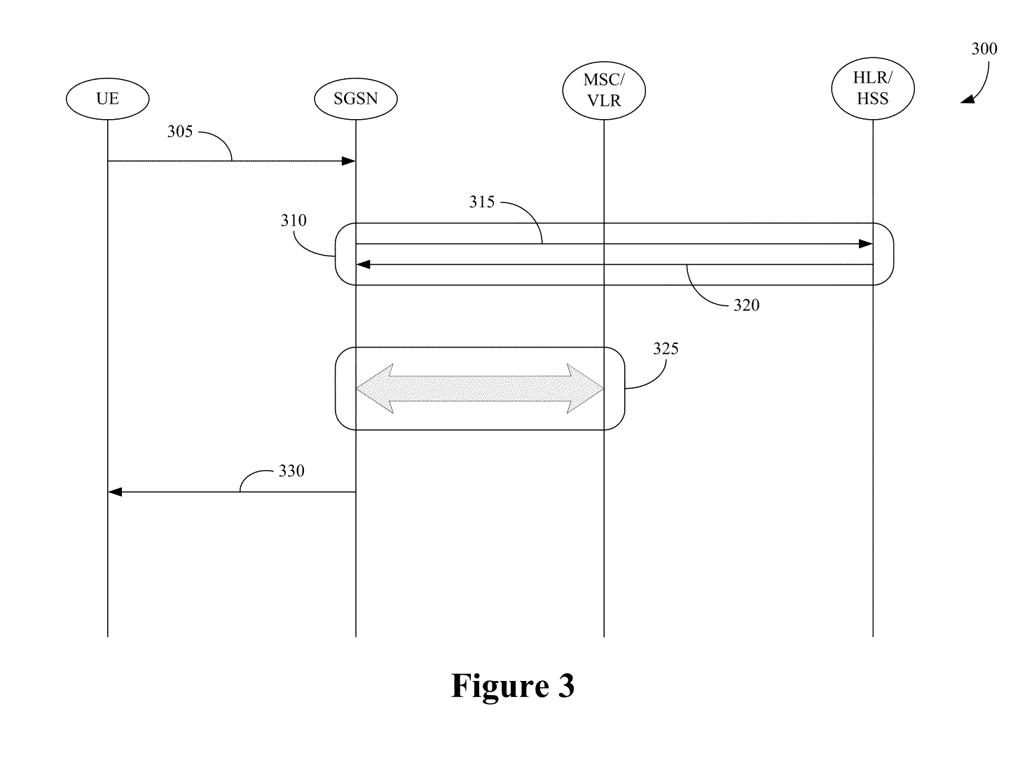

FIG. 3 conceptually illustrates a second exemplary embodiment of a method 300 of SMS-only messaging. In the illustrated embodiment, user equipment (UE) provides a request for services to an SGSN at 305. For example, the UE may provide (at 305) an ATTACH REQUEST that includes information indicating that the attach type is a combined GPRS service and non-GPRS service request so that the UE is requesting PS services and CS services. The ATTACH REQUEST may be transmitted when the UE first attaches to the wireless communication system. For another example, the UE may provide (at 305) a ROUTING AREA UPDATE REQUEST that includes information indicating that the attach type is a combined GPRS service and non-GPRS service request so that the UE is requesting PS services and CS services. The ROUTING AREA UPDATE REQUEST may be transmitted when the UE roams into a location area or routing area served by the SGSN. The ATTACH REQUEST or ROUTING AREA UPDATE REQUEST includes an additional parameter to indicate whether the UE is requesting for “SMS-only” service or not. This parameter is set to indicate that the UE is requesting SMS-only service in the illustrated embodiment.

In the second exemplary embodiment, the SGSN does not support SMS via PS domain NAS. The SGSN may therefore initiate an update location procedure 310 to the HLR/HSS by transmitting (at 315) signaling indicating that the SGSN does not support SMS via PS domain NAS and the UE has requested SMS-only service. The HLR/HSS responds (at 320) to the SGSN by signaling that SMS in SGSN is not supported. Some embodiments of the response (at 320) may include information indicating the UE's subscription info such as the SMS subscription data. For example, the HLR/HSS may retrieve this information from a database such as the user profiles 135 shown in FIG. 1. Since the SMS-only service is not supported by the PS domain, the SGSN establishes (at 325) a CS connection with the MSC/VLR, as indicated by the box 325. For example, the SGSN may perform a location update for non-GPRS services towards the VLR and may establish (at 325) a Gs association between the SGSN and the MSC/VLR. The SGSN may then signal (at 330) the UE that SMS via CS domain is provided for the SMS-only service. For example, the SGSN may transmit an Attach Accept message at 330.

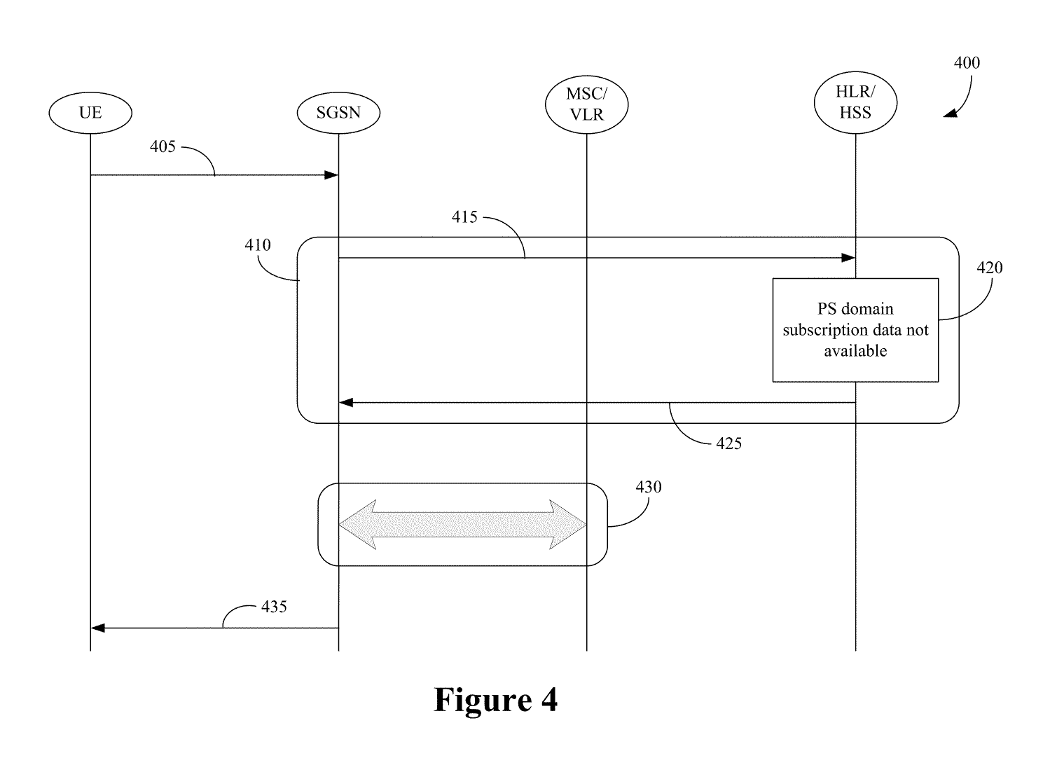

FIG. 4 conceptually illustrates a third exemplary embodiment of a method 400 of SMS-only messaging. In the illustrated embodiment, user equipment (UE) provides a request for services to an SGSN at 405. For example, the UE may provide (at 405) an ATTACH REQUEST that includes information indicating that the attach type is a combined GPRS service and non-GPRS service request so that the UE is requesting PS services and CS services. The ATTACH REQUEST may be transmitted when the UE first attaches to the wireless communication system. For another example, the UE may provide (at 405) a ROUTING AREA UPDATE REQUEST that includes information indicating that the attach type is a combined GPRS service and non-GPRS service request so that the UE is requesting PS services and CS services. The ROUTING AREA UPDATE REQUEST may be transmitted when the UE roams into a location area or routing area served by the SGSN. The ATTACH REQUEST or ROUTING AREA UPDATE REQUEST includes an additional parameter to indicate whether the UE is requesting for “SMS-only” service or not. This parameter is set to indicate that the UE is requesting SMS-only service in the illustrated embodiment.

In the third exemplary embodiment, the SGSN supports SMS via PS domain NAS. The SGSN may therefore initiate an update location procedure 410 to the HLR/HSS by transmitting (at 415) signaling indicating that the SGSN supports SMS via PS domain NAS and the UE has requested SMS-only service. However, in the third exemplary embodiment, the HLR/HSS determines (at 420) that the UE is not authorized for SMS via PS domain NAS, e.g., as indicated in the corresponding user profile such as one of the user profiles 135 shown in FIG. 1. The HLR/HSS responds (at 425) to the SGSN by signaling that the UE is not subscribed to SMS via PS domain NAS. Some embodiments of the response (at 425) may include information indicating the UE's subscription information. Since the UE is not subscribed to SMS via the PS domain, the SGSN establishes (at 430) a CS connection with the MSC/VLR. For example, the SGSN may perform a location update for non-GPRS services towards the VLR and may establish (at 430) a Gs association between the SGSN and the MSC/VLR. The SGSN may then signal (at 435) the UE that SMS via CS domain is provided for the SMS-only service. For example, the SGSN may transmit an Attach Accept message at 435.

One exemplary embodiment of an ATTACH REQUEST message according to some embodiments is shown below:

ATTACH REQUEST message content

| IEI | Information Element | Type/Reference | Presence | Format | Length |
|---|---|---|---|---|---|
| | Protocol discriminator | Protocol discriminator | M | V | ½ |
| | | 10.2 | | | |
| | Skip indicator | Skip indicator | M | V | ½ |
| | | 10.3.1 | | | |
| | Attach request message identity | Message type | M | V | 1 |
| | | 10.4 | | | |
| | MS network capability | MS network capability | M | LV | 3-9 |
| | | 10.5.5.12 | | | |
| | Attach type | Attach type | M | V | ½ |
| | | 10.5.5.2 | | | |
| | GPRS ciphering key sequence | Ciphering key sequence number | M | V | ½ |
| | number | 10.5.1.2 | | | |
| | DRX parameter | DRX parameter | M | V | 2 |
| | | 10.5.5.6 | | | |
| | Mobile identity | Mobile identity | M | LV | 6-9 |
| | | 10.5.1.4 | | | |
| | Old routing area identification | Routing area identification | M | V | 6 |
| | | 10.5.5.15 | | | |
| | MS Radio Access capability | MS Radio Access capability | M | LV | 6-51 |
| | | 10.5.5.12a | | | |
| 19 | Old P-TMSI signature | P-TMSI signature | O | TV | 4 |
| | | 10.5.5.8 | | | |
| 17 | Requested READY timer | GPRS Timer | O | TV | 2 |
| | value | 10.5.7.3 | | | |
| 9- | TMSI status | TMSI status | O | TV | 1 |
| | | 10.5.5.4 | | | |
| 33 | PS LCS Capability | PS LCS Capability | O | TLV | 3 |
| | | 10.5.5.22 | | | |
| 11 | Mobile station classmark 2 | Mobile station classmark 2 | O | TLV | 5 |
| | | 10.5.1.6 | | | |
| 20 | Mobile station classmark 3 | Mobile station classmark 3 | O | TLV | 2-34 |
| | | 10.5.1.7 | | | |
| 40 | Supported Codecs | Supported Codec List | O | TLV | 5-n |
| | | 10.5.4.32 | | | |
| 58 | UE network capability | UE network capability | O | TLV | 4-15 |
| | | 10.5.5.26 | | | |
| 1A | Additional mobile identity | Mobile identity | O | TLV | 7 |
| | | 10.5.1.4 | | | |
| 1B | Additional old routing area | Routing area identification 2 | O | TLV | 8 |
| | identification | 10.5.5.15a | | | |
| 5D | Voice domain preference and | Voice domain preference and UE's | O | TLV | 3 |
| | UE's usage setting | usage setting | | | |
| | | 10.5.5.28 | | | |
| D- | Device properties | Device properties | O | TV | 1 |
| | | 10.5.7.8 | | | |
| E- | P-TMSI type | P-TMSI type | O | TV | 1 |
| | | 10.5.5.29 | | | |
| C- | MS network feature support | MS network feature support | O | TV | 1 |
| | | 10.5.1.15 | | | |
| 14 | Old location area identification | Location Area Identification 2 | O | TLV | 7 |
| | | 10.5.5.30 | | | |
| F- | Additional update type | Additional update type | O | TV | 1 |
| | | 10.5.5.0 | | | |
| 10 | TMSI based NRI container | Network resource identifier container | O | TLV | 4 |
| | | 10.5.5.31 | | | |

One exemplary embodiment of the additional update type parameter can be coded as follows:

Additional update type information element

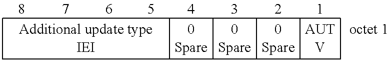

Additional update type value (AUTV) (octet 1)

| Bit | |
|---|---|
| 1 | |
| 0 | No additional information. If received it shall be interpreted as request |
| | for combined attach or combined routing area updating. |
| 1 | SMS only |

Bits 4 to 2 of octet 1 are spare and shall be all coded as zero.

One exemplary embodiment of an ROUTING AREA UPDATE REQUEST message according to some embodiments is shown below:

ROUTING AREA UPDATE REQUEST message content

| IEI | Information Element | Type/Reference | Presence | Format | Length |
|---|---|---|---|---|---|
| | Protocol discriminator | Protocol discriminator | M | V | ½ |
| | | 10.2 | | | |
| | Skip indicator | Skip indicator | M | V | ½ |
| | | 10.3.1 | | | |
| | Routing area update request | Message type | M | V | 1 |
| | message identity | 10.4 | | | |
| | Update type | Update type | M | V | ½ |
| | | 10.5.5.18 | | | |
| | GPRS ciphering key sequence | Ciphering key sequence number | M | V | ½ |
| | number | 10.5.1.2 | | | |
| | Old routing area identification | Routing area identification | M | V | 6 |
| | | 10.5.5.15 | | | |
| | MS Radio Access capability | MS Radio Access capability | M | LV | 6-51 |
| | | 10.5.5.12a | | | |
| 19 | Old P-TMSI signature | P-TMSI signature | O | TV | 4 |
| | | 10.5.5.8 | | | |
| 17 | Requested READY timer value | GPRS Timer | O | TV | 2 |
| | | 10.5.7.3 | | | |
| 27 | DRX parameter | DRX parameter | O | TV | 3 |
| | | 10.5.5.6 | | | |
| 9- | TMSI status | TMSI status | O | TV | 1 |
| | | 10.5.5.4 | | | |
| 18 | P-TMSI | Mobile identity | O | TLV | 7 |
| | | 10.5.1.4 | | | |
| 31 | MS network capability | MS network capability | O | TLV | 4-10 |
| | | 10.5.5.12 | | | |
| 32 | PDP context status | PDP context status | O | TLV | 4 |
| | | 10.5.7.1 | | | |
| 33 | PS LCS Capability | PS LCS Capability | O | TLV | 3 |
| | | 10.5.5.22 | | | |
| 35 | MBMS context status | MBMS context status | O | TLV | 2-18 |
| | | 10.5.7.6 | | | |
| 58 | UE network capability | UE network capability | O | TLV | 4-15 |
| | | 10.5.5.26 | | | |
| 1A | Additional mobile identity | Mobile identity | O | TLV | 7 |
| | | 10.5.1.4 | | | |
| 1B | Additional old routing area | Routing area identification 2 | O | TLV | 8 |
| | identification | 10.5.5.15a | | | |
| 11 | Mobile station classmark 2 | Mobile station classmark 2 | O | TLV | 5 |
| | | 10.5.1.6 | | | |
| 20 | Mobile station classmark 3 | Mobile station classmark 3 | O | TLV | 2-34 |
| | | 10.5.1.7 | | | |
| 40 | Supported Codecs | Supported Codec List | O | TLV | 5-n |
| | | 10.5.4.32 | | | |
| 5D | Voice domain preference and | Voice domain preference and UE's | O | TLV | 3 |
| | UE's usage setting | usage setting | | | |
| | | 10.5.5.28 | | | |
| E- | P-TMSI type | P-TMSI type | O | TV | 1 |
| | | 10.5.5.29 | | | |
| D- | Device properties | Device properties | O | TV | 1 |
| | | 10.5.7.8 | | | |
| C- | MS network feature support | MS network feature support | O | TV | 1 |
| | | 10.5.1.15 | | | |
| 14 | Old location area identification | Location Area Identification 2 | O | TLV | 7 |
| | | 10.5.5.30 | | | |
| F- | Additional update type | Additional update type | O | TV | 1 |
| | | 10.5.5.x | | | |

The additional update type parameter can be coded as discussed herein.

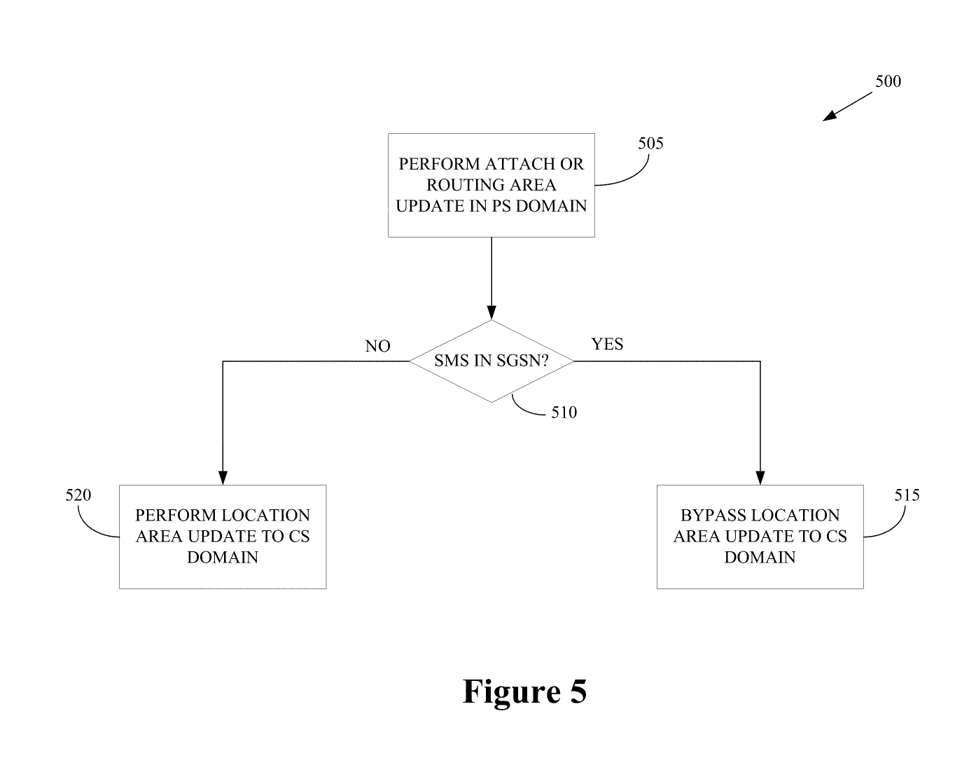

FIG. 5 conceptually illustrates one exemplary embodiment of a method 500 of handling SMS-only requests in systems that do not support combined requests for PS services and CS services. For example, the combined attach or routing area update procedures are supported by the GPRS networks that are operating in the first network mode of operation (NMO-I). However, GPRS networks that are operating in NMO-II or NMO-III do not support combined request for PS services and CS services. User equipment that are requesting SMS-only services may therefore register for PS services and include information in the request indicating the request for SMS-only services. Registration for CS services may then optionally be performed depending on the response received from the network.

In the illustrated embodiment, user equipment performs (at 505) an attach or routing area update in the PS domain. For example, user equipment may first perform (at 505) registration to the PS network via an Attach request or Routing area update request and then determine whether the SMS services can be supported by SGSN. If the user equipment receives (at 510) information indicating that the SMS services are supported by the SGSN, the user equipment can bypass (at 515) sending a location area update to the CS domain. Registration in the CS domain can therefore be skipped. If the user equipment receives (at 510) information indicating that the SMS services are not supported by the SGSN, the user equipment performs a location area update to request registration in the CS domain. The user equipment can then register in the CS domain so that SMS services can be provided by the CS domain via an MSC/VLR, as discussed herein. For example, if the GPRS UE receives in the ATTACH ACCEPT or ROUTING AREA UPDATE ACCEPT message an indication that SMS via GPRS is supported, then the GPRS UE shall not perform the CS domain specific procedure until a new ATTACH ACCEPT or ROUTING AREA UPDATE ACCEPT message indicating SMS via GPRS not supported or the GPRS UE does not wish to be IMSI attached only for GPRS and SMS-only service.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
providing, from user equipment, a request for packet-switched (PS) service or combined packet-switched (PS) service and circuit-switched (CS) service, wherein the request comprises an indication that the user equipment is requesting short message services (SMS) and is not requesting other CS services; and
receiving, at said user equipment, a response indicating whether the SMS services are supported by a PS domain.

2. The method of claim 1 wherein providing the request comprises providing at least one of an attach request or a routing area update request.

3. The method of claim 1, comprising bypassing establishment of a CS connection for the user equipment in response to receiving an indication that the SMS services are supported by the PS domain.

4. The method of claim 3, wherein receiving the response indicating that the SMS services are supported by the PS domain comprises receiving an indication that the SMS services are supported by a serving General Packet Radio Service (GPRS) support node (SGSN) using non-access stratum (NAS) signaling.

5. The method of claim 1, comprising establishing a CS connection for the user equipment in response to receiving an indication that the SMS services are not supported by the PS domain.

6. A method, comprising:
receiving, at a node in a packet-switched (PS) network, a request for PS service or combined PS service and circuit-switched (CS) service for user equipment, wherein the request comprises an indication that the user equipment is requesting short message services (SMS) and is not requesting any other CS services;
providing, from the node, signaling indicating that the node supports the SMS services and indicating that the request is for SMS-only service: and
receiving, at the node in response to providing said signaling, a response indicating whether the SMS services are supported by a PS domain.

7. The method of claim 6, wherein providing the request comprises providing at least one of an attach request or a routing area update request.

8. The method of claim 6, wherein providing said signaling comprises providing said signaling to a home location register (HLR)/home subscriber server (HSS).

9. The method of claim 8, wherein receiving the response comprises receiving a response from the HLR/HSS indicating that the HLR/HSS supports SMS services in the PS domain, and wherein the response comprises an indication that the SMS services are supported by the PS domain and subscription information associated with said user equipment.

10. The method of claim 9, wherein the node is a serving General Packet Radio Service (GPRS) support node (SGSN), and wherein receiving the indication that the SMS services are supported by the PS domain comprises receiving an indication that the HLR/HSS supports the SMS services for the SGSN using non-access stratum (NAS) signaling.

11. The method of claim 10, comprising bypassing performance of a location update for CS service and bypassing establishment of a CS connection with said user equipment in response to receiving the indication that the HLR/HSS supports the SMS services for the SGSN.

12. The method of claim 8, wherein receiving the response comprises receiving a response from the HLR/HSS indicating that the HLR/HSS does not support SMS services in the PS domain.

13. The method of claim 12, wherein the node is a serving General Packet Radio Service (GPRS) support node (GGSN), and wherein receiving the indication that the SMS services are not supported by the PS domain comprises receiving an indication that the HLR/HSS does not support the SMS services for the SGSN using non-access stratum (NAS) signaling or subscription information for said user equipment is not available at the HLR/HSS.

14. The method of claim 13, comprising performing a location update for CS service and establishing a CS connection with said user equipment in response to receiving the indication that the HLR/HSS does not support the SMS services for the SGSN.

15. User equipment configured to:
provide a request for packet-switched (PS) service or combined packet-switched (PS) service and circuit-switched (CS) service, wherein the request comprises an indication that the user equipment is requesting short message services (SMS) and is not requesting any other CS services; and
receive a response indicating whether the SMS services are supported by a PS domain.

16. The user equipment of claim 15, wherein the user equipment is configured to provide at least one of an attach request or a routing area update request.

17. The user equipment of claim 15, wherein the user equipment is configured to establish CS connection in response to receiving an indication that the SMS services are supported by the PS domain.

18. The user equipment of claim 17, wherein the user equipment is configured to establish CS connection in response to receiving an indication that the SMS services are supported by a serving General Packet Radio Service (GPRS) support node (SGSN) using non-access stratum (NAS) signaling.

19. The user equipment of claim 15, wherein the user equipment is configured to establish a CS connection in response to receiving an indication that the SMS services are not supported by the PS domain.

20. A node configured for implementation in a packet-switched (PS) network, the node being configured to:
receive a request for packet-switched (PS) service or combined packet-switched (PS) service and circuit-switched (CS) service for user equipment, wherein the request comprises an indication that the user equipment is requesting short message services (SMS) and is not requesting any other CS services;
provide signaling indicating that the node supports the SMS services and indicating that the request is for SMS-only service: and
receive, in response to providing said signaling, a response indicating whether the SMS services are supported by a PS domain.

21. The node of claim 20, wherein the node is configured to provide at least one of an attach request or a routing area update request.

22. The node of claim 20, wherein the node is configured to provide said signaling to a home location register (HLR)/home subscriber server (HSS).

23. The node of claim 22, wherein the node is configured to receive a response from the HLR/HSS indicating that the HLR/HSS supports SMS services in the PS domain, and wherein the response comprises an indication that the SMS services are supported by the PS domain and subscription information associated with said user equipment.

24. The node of claim 23, wherein the node is a serving General Packet Radio Service (GPRS) support node (SGSN), and wherein receiving the indication that the SMS services are supported by the PS domain comprises receiving an indication that the HLR/HSS supports the SMS services for the SGSN using non-access stratum (NAS) signaling.

25. The node of claim 24, wherein the node is configured to bypass performance of a location update for CS service and bypass establishment of a CS connection with said user equipment in response to receiving the indication that the HLR/HSS supports the SMS services for the node.

26. The node of claim 20, wherein the node is configured to receive a response from the HLR/HSS indicating that the HLR/HSS does not support SMS services in the PS domain.

27. The node of claim 26, wherein the node is a serving General Packet Radio Service (GPRS) support node (GGSN), and wherein receiving the indication that the SMS services are not supported by the PS domain comprises receiving an indication that the HLR/HSS does not support the SMS services for the SGSN using non-access stratum (NAS) signaling or subscription information for said user equipment is not available at the HLR/HSS.

28. The node of claim 27, wherein the node is configured to perform a location update for CS service and establish a CS connection with said user equipment in response to receiving the indication that the HLR/HSS does not support the SMS services for the SGSN.
